(19) United States
(12) Patent Application Publication
(10) Pub. No.: US 2010/0042982 A1
(43) Pub. Date: Feb. 18, 2010

(54) OPTIMIZATION OF IMPERATIVE IMPLEMENTATION OF COMPOSITIONAL CONTENT

(75) Inventors: Avner Aharoni, Seattle, WA (US); Henricus Johannes Maria Meijer, Mercer Island, WA (US); David N. Schach, Redmond, WA (US); Andrew Kimball, Sammamish, WA (US); Ghanashyam Namboodiripad, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/192,398

(22) Filed: Aug. 15, 2008

(51) Int. Cl. G06F 9/45

(52) U.S. Cl. 717/151

(57) ABSTRACT

Compositional program content is compiled to statements of an imperative application interface in manners that optimize execution and/or resource utilization, among other things. In one instance, a constructor is employed in a manner that obviates a need for extensive memory allocation and parameter copying. Names and namespaces are also cached to avoid expensive table lookup, and redundant namespace declarations are removed and/or moved statically and/or dynamically.

### BACKGROUND

A programmer utilizing a programming language creates the instructions comprising a computer program. Typically, source code is specified or edited by a programmer manually and/or with help of an integrated development environment (IDE) comprising numerous development services (e.g., editor, debugger, auto fill, intelligent assistance . . . ). By way of example, a programmer may choose to implement source code utilizing an object-oriented programming language (e.g., C#, VB, Java . . . ) where programmatic logic is specified as interactions between instances of classes or objects, among other things. Subsequently, the source code can be compiled or otherwise transformed to another form to facilitate execution by a computer or like device.

A compiler conventionally produces code for a specific target from source code. For example, some compilers transform source code into native code for execution by a specific machine. Other compilers generate intermediate code from source code, where this intermediate code is subsequently interpreted dynamically at run time or compiled just in time (JIT) to facilitate execution across computer platforms, for instance. Further yet, some compilers are utilized by IDEs to perform background compilation to aid programmers by identifying actual or potential problems, among other things.

Compilers perform lexical, syntactic, and semantic analysis as well as code generation. A scanner or lexer performs lexical analysis to convert a sequence of characters into tokens based on a program language specification. A parser performs syntactic analysis of tokens provided by the lexer in an attempt to determine structure and often captures such structure in a parse tree in accordance with a formal language grammar. Subsequently, semantic analysis can be performed with respect to the parse tree to determine meaning associated with the code as well as perform type checking and binding, among other things. Finally, a code generator produces code in a target language as a function of the analysis performed.

Program languages can support language-integrated queries and literals, among other things as native or first-class constructs. For example, an object-oriented language such can host a markup language expression. A compiler associated with the host language can ensure that the foreign constructs are transformed into host language constructs at compile time.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to optimization of an imperative implementation of compositional content. More specifically, a compiler transforms compositionally specified input into statements associated with an imperative application-programming interface in a manner that not only captures the functionality and/or structure specified thereby but also optimizes performance in terms of execution, resource utilization, and the like. In accordance with one aspect of the disclosure, the input elements are constructed in a manner that avoids unnecessary memory allocation and copying. According to another aspect, namespace and/or names are constructed as reusable variable objects that are cached to avoid at least expensive table lookups and string comparisons. In accordance with yet another aspect, redundant namespace declarations are removed statically at compile time and/or dynamically at runtime.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a compiler system in accordance with an aspect of the disclosed subject matter.

FIG. 2 is a block diagram of a representative transformation component according to an aspect of the disclosure.

FIG. 3 is a block diagram of a representative construction component according to a disclosed aspect.

FIG. 4 is a block diagram of a representative cache component in accordance with an aspect of the disclosed subject matter.

FIG. 5 is a block diagram of a representative namespace component according to an aspect of the disclosure.

FIG. 6 is a block diagram of a namespace removal system in accordance with an aspect of the disclosure.

FIG. 7 is a flow chart diagram of a compilation method in accordance with a disclosed aspect.

FIG. 8 is a flow chart diagram of a method of constructing compositional elements in terms of imperative statements according to a disclosed aspect.

FIG. 9 is a flow chart diagram of a method of caching namespaces and/or names according to an aspect of the disclosure.

FIG. 10 is a flow chart diagram of a method of removing namespace declarations in accordance with an aspect of the disclosure.

FIG. 11 is a flow chart diagram of a compile-time method of namespace removal according to a disclosed aspect.

FIG. 12 is a flow chart diagram of a runtime method of namespace removal in accordance with an aspect of the disclosed subject matter.

FIG. 13 is a schematic block diagram illustrating a suitable operating environment for aspects of the subject disclosure.

FIG. 14 is a schematic block diagram of a sample-computing environment.

### DETAILED DESCRIPTION

Systems and methods pertaining to program optimization are described in detail hereinafter. Code and/or data constructed in a compositional manner is mapped to an imperative implementation in a manner that optimizes performance and resource utilization, among other things. In one instance, this can be accomplished by employing a constructor that does not utilize a parameter array, and calling add methods in conjunction with child elements and/or attributes. In addition, namespaces and/or names can be embodied as objects and cached to facilitate reuse. Further yet, redundant namespace declarations can be removed at compile time and/or runtime.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

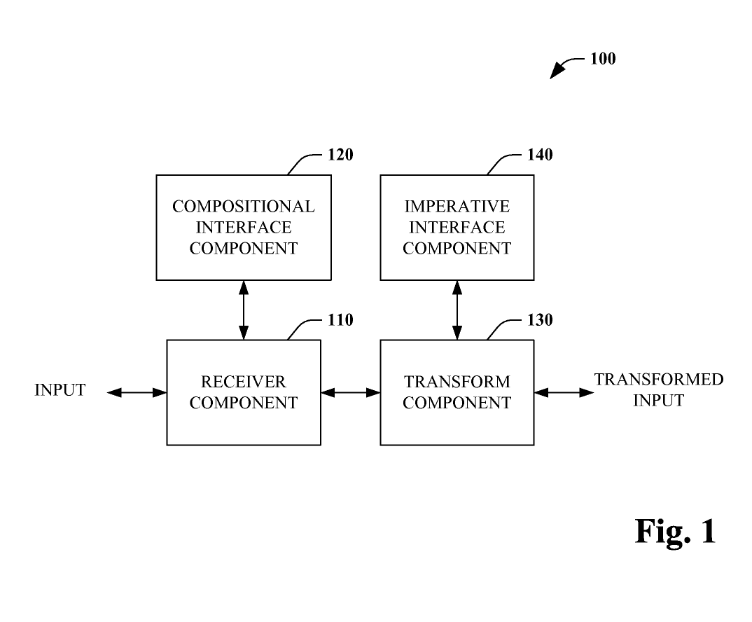

Referring initially to FIG. 1, a compiler system 100 is illustrated in accordance with an aspect of the claimed subject matter. The system 100 includes a receiver component 110 that receives, retrieves, or otherwise obtains or acquires input. According to an aspect, the input can be specified in a compositional manner in accordance with compositional language support and/or a compositional application-programming interface (API) 120. Transformation component 130 transforms or maps the compositional input to statements or the like associated with an imperative application-programming interface (API) 140. Moreover, the transformation is performed in a manner that optimizes input processing and/or system resource utilization, among other things.

It is to be appreciated that the system 100 can be employed in many different scenarios and/or embodiments. However, solely for purposes of clarity and understanding this detailed description with focus on one particular context namely integration of an extensible markup language in general and more specifically the extensible markup language (XML) open standard that provides a general purpose specification for custom markup languages. Of course, integration of other languages and different embodiments are also possible and contemplated. For example, in addition to XML, the system 100 and aspects described hereinafter can operate similarly or analogously with respect to object initializers and strings.

In this context, the input to the system 100 can be markup code integrated within a host language. The imperative API 140 can provide functionality for implementing the markup code or XML in the context of a host language such as Visual Basic, for example. This is advantageous at least because it is composable such that simple expressions can be combined to create complex XML documents and the code is easily readable and maintainable in that expressions are structurally similar to XML. By way of example and not limitation, consider the following code sample that illustrates how XML can be created within a host language utilizing functionality provided the imperative API 130.

```
Function f1( ) As XElement
      Return New XElement(XName.Get(“a”, “Namespace”), _{—}
            New XAttribute(XNamespace.Xmlns.GetName(“p”), _{—}
              “Namespace”), _{—}
            New XElement(XName.Get(“b”, “Namespace”)), _{—}
            New XElement(XName.Get(“b”, “Namespace”)))
End Function
```

This program creates the following structure:

```
<p:a xmlns:p=”Namespace”>
      <p:b/>
      <p:b/>
</p:a>
```

The input received by the system 100 need not be in this imperative form rather it can be compositional. More specifically, XML literals can be employed that hide calls to the API 130 and let a programmer use XML as a built-in data type much like the way programmers use numbers, strings, and other intrinsic data types. Using XML literals, the above function can be written as follows:

```
Imports <xmlns:p=“Namespace”>
Function f2( ) As XElement
    Return <p:a>
              <p:b/>
              <p:b/>
          </p:a>
End Function
```

A naive implementation of XML literals transforms the code in function “f2” directly into the code in function “f1”. However, this implementation is not optimal in terms of performance and resource utilization. For example, a conventional constructor uses a parameter array to handle an optional number of parameters that are passed to the constructor. In this case, the compiler allocates an object array for each call and initializes it with a constructed element's content. This array is then passed to the constructor, which immediately removes the parameters from the array. Using the parameter array is convenient for programmers, but it adds the cost of an extra memory allocation and parameter copies. Instead of using such a constructor, an alternate constructor is provided as part of the imperative interface or API component 140, for instance, that does not include the parameter array but solely a name of the element as an argument, for example. Employment of this constructor is described in the next section.

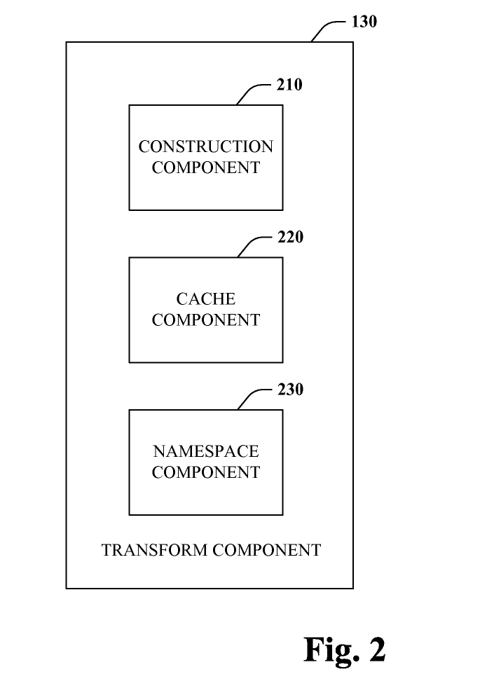

FIG. 2 depicts a representative transform component 130 in accordance with an aspect of the claimed subject matter. As previously mentioned, the transformation component 130 does not simply transform compositional input such as XML literals into one or more statements associated with an imperative API, but rather it performs such transformation so as to optimize performance, memory utilization, and the like. In furtherance thereof, the transformation component 130 includes a plurality of sub-components that correspond to particular mechanisms for optimizing the transformation, namely construction component 210, cache component 220, and namespace component 230. Of course, others are possible, contemplated, and intended to be within the scope and spirit of the subject claims. Briefly, the construction component 210 produces elements of an input such as an XML element utilizing a constructor that does not employ a parameter array but does utilize a plurality of add method calls. The cache component 220 caches namespaces and/or names to facilitate subsequent reuse, and the namespace component 230 removes redundant namespaces at compile time and/or runtime.

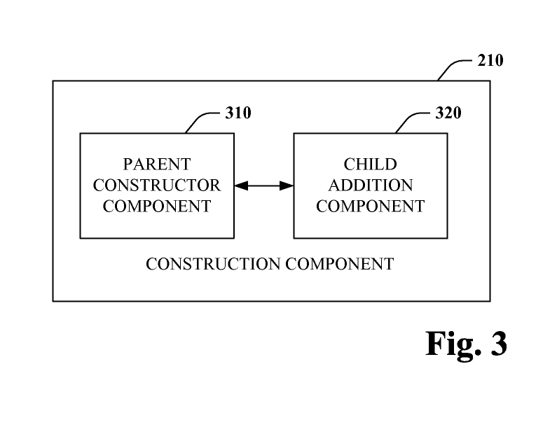

FIG. 3 illustrates a representative construction component 210 in accordance with an aspect of the claimed subject matter. As shown, the construction component 210 includes a parent constructor component 310 and a child addition component 320. The parent construction component 310 utilizes a constructor, which does not produce a parameter array, to construct parent or container content such as an XML element. The child addition component 320 adds child or contained content such as elements and/or attributes, among other things, to the parent or container. For example, a series of add method calls can be made for each child element or attribute. Explicit addition of dependent content via an add method, for example, obviates any need for a parameter array. Moreover, such code can execute significantly faster while avoiding unnecessary memory allocation and copying. Among other things, this can be significant when arguments are computed using a query. By directly adding results one by one, evaluation of a complete query need not be forced into a single large array. Below is a an exemplary code sample of function “f3” illustrating operations performed by the parent constructor component 310 and the child addition component 320 in accordance with an aspect of the claimed subject matter:

```
Function f3( ) As XElement
    Dim x = New XElement(XName.Get(“a”, “Namespace”))
    x.Add(New XAttribute(XNamespace.Xmlns.GetName(“p”),
    “Namespace”))
    x.Add(New XElement(XName.Get(“b”, “Namespace”)))
    x.Add(New XElement(XName.Get(“b”, “Namespace”)))
    Return x
End Function
```

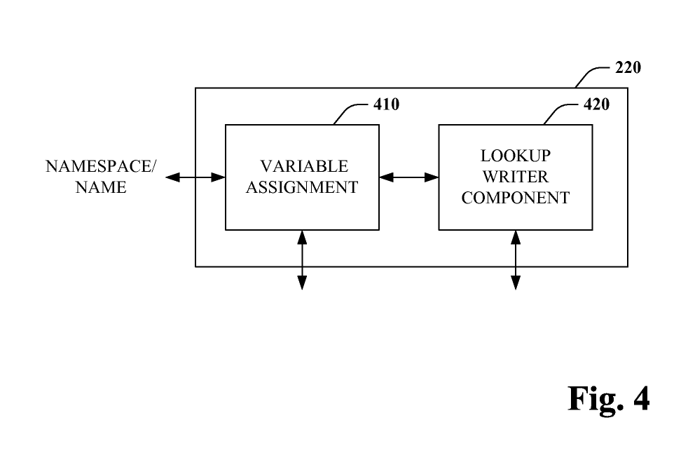

Turning attention to FIG. 4, a representative cache component 220 is depicted in accordance with an aspect of the claimed subject matter. As previously described, the cache component 220 can cache namespaces and/or names to enable reuse, among other things. The cache component 220 includes a variable assignment component 410 and a lookup writer component 420. The variable assignment component 410 assigns a namespace declaration to a variable, of a particular object type that is cached. The lookup writer component 320 can construct namespace name lookups utilizing object message passing as well as assign the results to a cached variable.

Typically, names of content elements or attribute are atomized in a name table including instances of the name objects and namespace object in order to reduce the amount of string comparisons. However, by computing a unique object for each name string, the names can be compared using object identity, which is a constant time operation rather than string comparison, which is a linear time operation.

More specifically, strings can be used to create and refer to names as well as namespace objects. The following code snippets shows a simple way to create an XML element:
Dim x2=New XElement(XName.Get(“Name”, “http://mynamespace”))

One way to improve performance is to create variables that hold references to actual “XName” and “XNamespace” objects. Using such variables instead of strings has substantial performance improvement benefits. For example, the above code can be transformed into the following:

Dim ns = XNamespace.Get(“http://mynamespace”)
Dim n = ns.GetName(“Name”)

Here, the string “http://mynamespace” is first converted to an “XNamespace” object and the string “Name” is looked up in the “XNamespace” to return the “XName” object.

In an XML document, namespaces and names are often used multiple times. For example, it is common for all names to in be in one or two namespaces. Rather than look up the name and namespace on each constructor call, it is advantageous to hoist the namespace and names in variables so that they can be reused. While name reuse is less common than namespace reuse, it still occurs frequently in sections of repeating elements such as:

```
<p:customerList>
    <p:customer>
        <p:name/>
        <p:address/>
        <p:city/>
        <p:state/>
        <p:zip/>
    </p:customer>
    <!-customer element repeats multiple times -->
    ...
</p:customerList>
```

The example above can then be compiled as follows to leverage caching of both namespace and names as follows:

Dim ns As XNamespace = XNamespace.Get(“http://mynamespace”)
Dim n1 = ns.GetName(“customerList”)
Dim n2 = ns.GetName(“customer”)
Dim n3 = ns.GetName(“name”)
Dim n4 = ns.GetName(“address”)
Dim n5 = ns.GetName(“city”)
Dim n6 = ns.GetName(“state”)
\grave{ }first customer element
Dim e1 = new XElement(n1)
Dim e2 = new XElement(n2)
Dim e3 = new XElement(n3)
Dim e4 = new XElement(n4)
Dim e5 = new XElement(n5)
Dim e6 = new XElement(n6)
\grave{ }next customer element
Dim e1 = new XElement(n1)
Dim e2 = new XElement(n2)
Dim e3 = new XElement(n3)
Dim e4 = new XElement(n4)
Dim e5 = new XElement(n5)
Dim e6 = new XElement(n6)

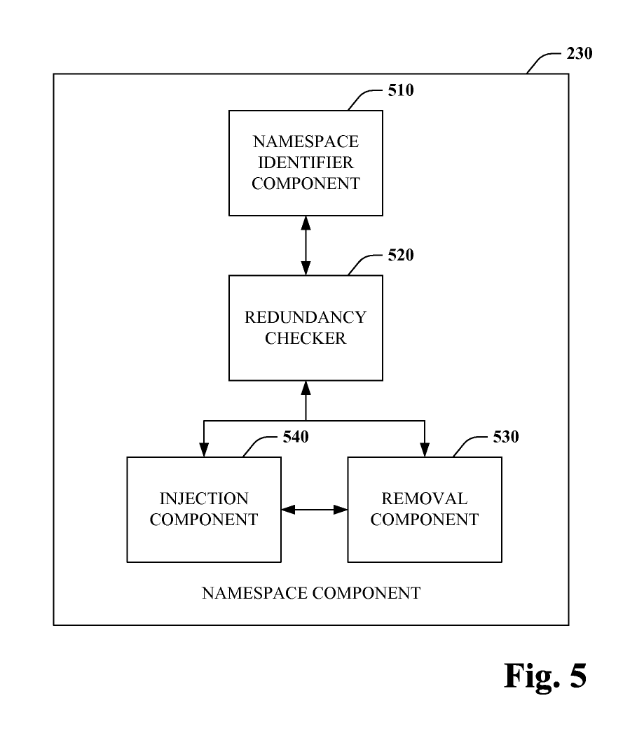

Referring to FIG. 5, a representative namespace component 230 in depicted in accordance with an aspect of the claimed subject matter. The namespace component 230 is a mechanism that removes redundant namespace declarations that occur when combining fragments to produce an aggregate, for instance. By way of example and not limitation, there may be redundant XML namespace declarations created when assembling an XML document from multiple functions and embedded queries, since each XML fragment is created with namespace declarations for that element. When combined with another fragment, the namespace declarations for the element may already appear on a parent or ancestor element.

The namespace component 230 includes an identifier component 510 that identifies namespaces in an input. Identified namespaces are provided or made available to redundancy checker component 520, which analyzes the namespaces in an attempt to identify redundant or otherwise unnecessary namespace declarations. For example, if a parent element and a child element both include namespace declarations, one of them is unnecessary. Removal component 530 is communicatively coupled to the redundancy checker component 520 and is able to remove identified redundant or unnecessary namespace declarations. In some cases, the removal component 530 can simply remove a declaration such as in the previous example where the child element declaration can be eliminated. However, in some other cases, the redundancy checker component 520 can employ injection component 540 alone or in conjunction with remove component 530. The injection component 540 adds a namespace declaration to a location. Together with the remove component 530, a movement of a namespace declaration from a first location to a second location can be effected. For instance, consider a scenario in which an identical namespace declaration is present on multiple child elements. In this case, the namespace declaration can be injected into a parent element and removed from the children.

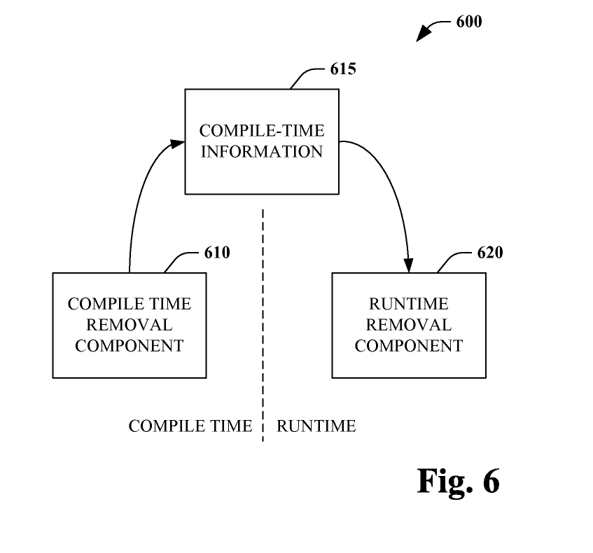

FIG. 6 illustrates a namespace-declaration removal system 600 in accordance with an aspect of the claimed subject matter. As shown, the system 600 includes a compile time removal component 610 and a runtime removal component 620. Each of these components can have similar functionality as described with respect to the representative namespace component 230 of FIG. 5. In particular, both removal components 610 and 620 can include functionality for identify redundant and/or unnecessary namespace declarations and removing and/or injecting declarations. Furthermore, the compile-time removal component 610 can enable transformation of information collected at compile time 615 and passing it to runtime removal component 620 that can utilize this information to facilitate redundancy identification and removal. In some cases, a determination cannot be made regarding namespace removal statically at compile time. The determination may be able to be made dynamically at runtime. Accordingly, information collected at compile-time such as a list of namespaces and scopes can be provided to the runtime removal component 620 to avoid performance of duplicative work where possible. In accordance with one embodiment, this can be accomplished by generating a call to a runtime helper function at compile time that performs or initiates performance of the same check at runtime when an XML document is assembled, for example.

In accordance with one aspect, various rules can be provided to configure namespace removal and/or movement. By way of example and not limitation consider the following rules: 1) Only move global namespaces that are defined using an imports statement, and local declarations that match global declarations; 2) When matching namespaces match both a prefix and the namespace itself; 3) Within a literal move the namespaces at compile time when the compiler can statically determine that a declaration can be moved; and 4) If the compiler cannot statically determine if a declaration can be moved, generate a call to a runtime function to perform the same check at runtime. Of course, many other and/or different rules can be utilized to tailor performance to different systems and/or scenarios.

What follows is a set of examples to aid clarity in understanding how namespace removal and/or movement can be performed. Of course, these are only examples and as such are not intended to limit the scope of the claimed subject matter in any manner but merely to aid understanding through example.

The first example illustrates a simple movement or injection of the declaration into the top level. Consider the following code snippet:

```
Imports <xmlns:a=“http://mynamespace1”>
Dim doc = <level0>
              <level1>
                  <a:level2></a:level2>
              </level1>
          </level0>
```

The output shows injection of the namespace declaration at the top level “level0”:

```
<level0 xmlns:a=“http://mynamespace1”>
  <level1>
    <a:level2></a:level2>
  </level1>
</level0>
```

The second example illustrates implementation of a rule that only globally declared naemspace declarations will be bubbled up. As shown below, there is a local declaration “b” and global declaration “a”

```
Imports <xmlns:a=“http://mynamespace1”>
Dim doc3 = <level0>
              <b:level1 xmlns:b=“http://Othernamespace”>
                  <a:level2></a:level2>
              </b:level1>
          </level0>
```

The output indicates that only the global declaration “a” is bubbled to the top, “level0”, while the local declaration “b” remains at “level1”.

```
<level0 xmlns:a=“http://mynamespace1”>
  <b:level1 xmlns:b=“http://Othernamespace”>
    <a:level2></a:level2>
  </b:level1>
</level0>
```

The third example illustrates how different namespace prefixes affect a removal/move process. As specified below, the global namespace and a local namespace are equivalent by include a different prefix:

```
Imports <xmlns:a=“http://mynamespace1”>
Dim doc4 = <level0>
              <b:level1 xmlns:b=“http://mynamespace1”>
                  <a:level2></a:level2>
              </b:level1>
          </level0>
```

The output shows that where namespace prefixes do not match, but an alternate prefix is in scope on the element, then the local declaration is removed and the alternate prefix is employed.

```
<level0 xmlns:a=“http://mynamespace1”>
  <a:level1>
    <a:level2></a:level2>
  </a:level1>
</level0>
```

The next example includes embedded expressions. Consider the following code snippet:

```
Imports <xmlns:a=“http://mynamespace1”>
Dim doc5 = <level0>
              <%= From i In Enumerable.Range(1, 3) _{—}
                  Select <a:level1 xmlns:a=“http://mynamespace1”>
                          <a:level2></a:level2>
                      </a:level1> _{—}
              %>
          </level0>
```

The output shows movement of the namespace declaration to the top level “level0”

```
<level0 xmlns:a=“http://mynamespace1”>
  <a:level1>
    <a:level2></a:level2>
  </a:level1>
  <a:level1>
    <a:level2></a:level2>
  </a:level1>
  <a:level1>
    <a:level2></a:level2>
  </a:level1>
</level0>
```

The follow example illustrates a case where the namespace cannot is removed at runtime since it cannot be removed:

```
Imports <xmlns:a=“http://mynamespace1”>
Dim doc6 = <level0 xmlns:a=“http://mynamespace1”>
                  <%= GetElements( ) %>
              </level0>
Function GetElements( ) As IEnumerable(Of XElement)
    Return From i In Enumerable.Range(1, 3) _{—}
        Select <a:level1>
                <a:level2></a:level2>
            </a:level1>
End Function
```

The output is as follows:

```
<level0 xmlns:a=“http://mynamespace1”>
  <a:level1>
    <a:level2></a:level2>
  </a:level1>
  <a:level1>
    <a:level2></a:level2>
  </a:level1>
  <a:level1>
    <a:level2></a:level2>
  </a:level1>
```

In accordance with an aspect of the claimed subject matter, a remove namespace method can be invoked by a compiler system to remove redundant namespace declarations. The following a non-limiting exemplary method signature that can be employed with respect XML.

Function RemoveNamespaces(InScopeNamespaces as
List(of XAttribute), AttributesToAddToRoot as List(Of XAttribute),
e as XElement) as XElement

The calling code passes in a list of all in scope namespace attributes, an empty list of attributes and an element to process. The “RemoveNamespace” method will look at each namespace attribute on “e” and process it according to the table below. During the processing the “RemoveNamespace” method will remove namespace attributes from “e” and possibly add them to the in scope namespace list and the “addtoroot” list. All namespaces in the “addtoroot” list will be added to the root of the XML fragment once the fragment is constructed.

TABLE 1

| Is | | | |
|---|---|---|---|
| Prefix | Is Prefix is | Is | |
| In | for this | Namespace | |
| Scope? | Namespace | In Scope? | Action |
| Yes | Yes | Yes | The namespace attribute on the |
| | | | element is already in scope. |
| | | | Remove namespace attribute from |
| | | | the element. |
| Yes | No | No | The prefix is in scope and used by |
| | | | another namespace. The |
| | | | namespace attribute must remain |
| | | | on the element. |
| No | N/A | No | The prefix and namespace are not |
| | | | in scope. Remove the attribute |
| | | | from e and add it to the in scope |
| | | | namespace attributes and the |
| | | | attributes to add to the root |
| | | | element. |

As mentioned previously, the transform component 130 is not limited to the optimizations described above as well as below. Various other tweaks can be made to the manner in which input is transformed. By way of example and not limitation, parallelism or more parallelism can be introduced with respect to input processing.

In addition, to optimization the subject techniques can guard against changes in an underlying API. Suppose, for instance, that a different API is developed or changes like bug fixes occur. These changes can be incorporated into a compiler so as to effect the changes for all programs by changing the code generation. Alternatively, if code were hand-written, every programmer would have to update his/her code. This is not some much an optimization but it leverages the fact that the compiler is generating actual calls to the underlying API.

Further yet, functionality associated with or described with respect to a particular context can be abstracted and employed for alternate and even disparate use. For instance, the system 600 of FIG. 6 can be analogously employed with respect to static and dynamic validation. XML often has a schema associated with a document that describes valid XML. Given a parent element, what are the acceptable child elements? Similar functionality can be employed wherein static validation is performed as much as possible and then information regarding static validation is passed into a runtime that performs dynamic validation.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, a compiler system can utilize such mechanism to infer application of appropriate optimization. In one particular instance, inferences can be made compile time to aid identification and removal of redundant namespace declarations that otherwise would not be able to be done statically.

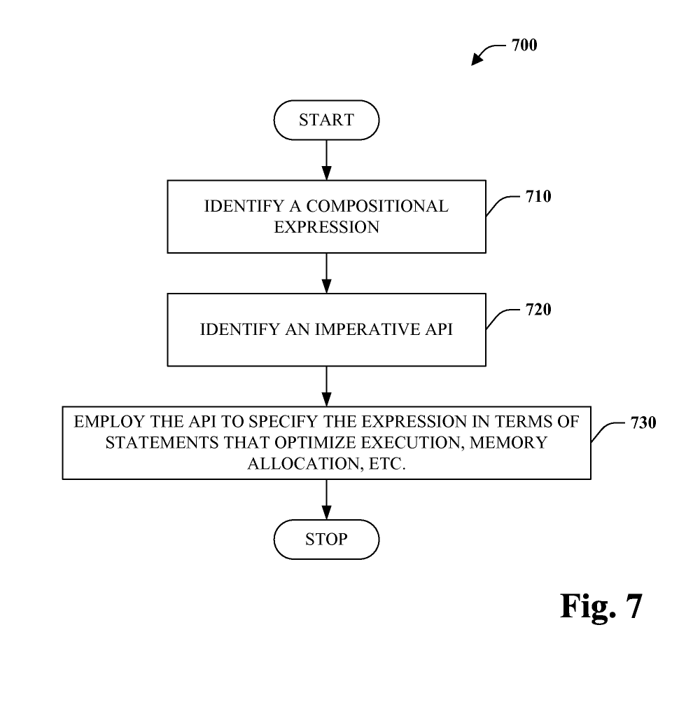

In view of the exemplary systems described supra, methodologies that may be implemented in accordance with the disclosed subject matter will be better appreciated with reference to the flow charts of FIGS. 7-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a compilation method 700 is illustrated in accordance with an aspect of the claimed subject matter. At reference numeral 710, compositional input or content in the form of an expression, for instance, is identified. Such content can be a product of built in compositional language support and/or a compositional application-programming interface, among other things. By way of example, the content can be embodied as a language integrated markup language such as an XML literal, or alternatively an object initializer or string. At numeral, 720 an imperative application-programming interface (API) is identified that is associated with the compositional content. At 730, the compositional content is specified in terms of statements associated with the imperative API in a manner that not only captures the functionality and/or structure specified thereby but also optimizes performance in terms of execution, memory allocation, etc.

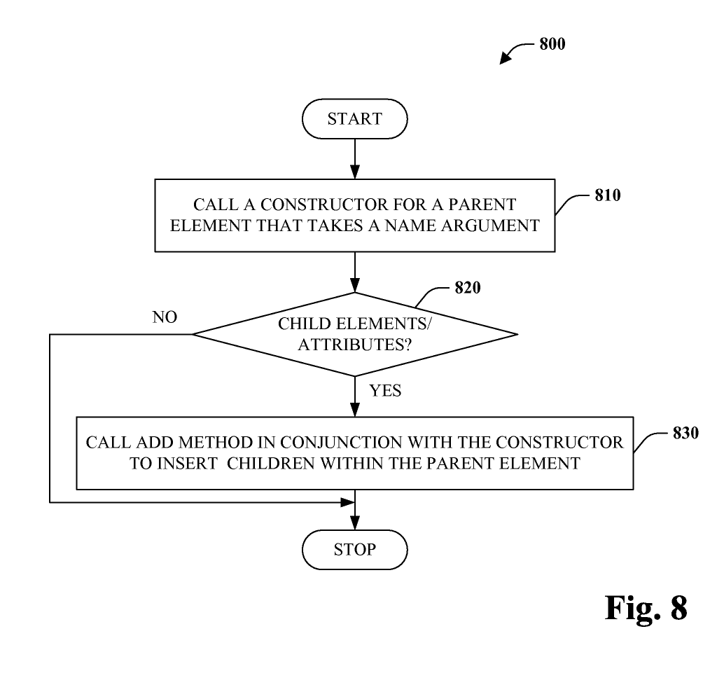

FIG. 8 is a flow chart diagram of a method 800 of constructing compositional elements in terms of imperative statements according to an aspect of the claimed subject matter. At reference numeral 810, a constructor is called to produce a parent element, wherein the constructor does require a parameter array but rather simply an element name and optionally other things. The constructor forms part of an imperative application interface, for instance. At numeral 820, a determination is made as to whether there are any children or dependent elements, attributes, or the like. If no, the method simply terminates. If yes, the method continues at reference numeral 830 where an add method is called in conjunction with a constructor to insert child elements, attribute, or the like within or contained by a parent. Among other things, this obviates the need for a parameter object array and optimizes performance by avoiding unnecessary memory allocation.

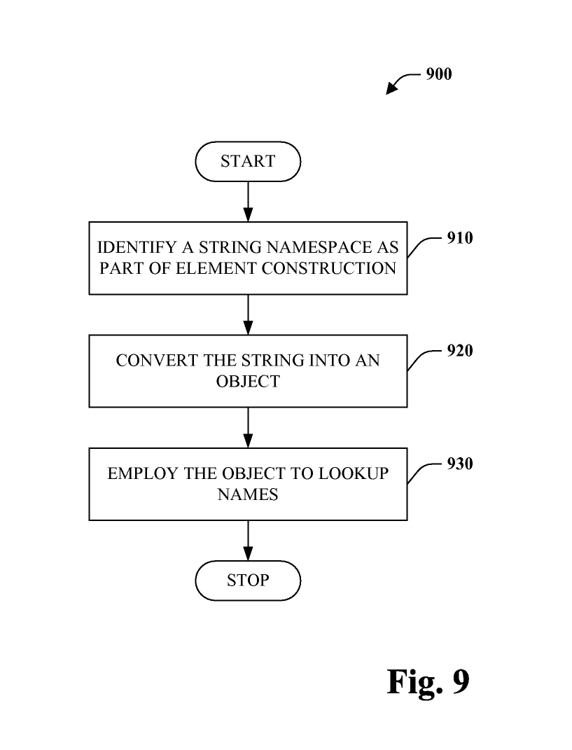

FIG. 9 is a method of namespace and/or name caching 900 according to an aspect of the claimed subject matter. At reference numeral 910, a string namespace associated with element construction, for example, is identified. The namespace is converted to an object, at numeral 920. This object can be a variable that is cached. At reference numeral 930, the object is employed to facilitate name lookup. In particular, a name can be looked up in the namespace object resulting in a returned name object, for instance. This can avoid a potentially expensive table lookup and/or string comparison when constructing elements, among other things. It is to be noted that while name reuse is not as common as namespace reuse, it still occurs frequently. Accordingly, method 900 can also be employed to transform string names into object variables that can be employed to aid construction.

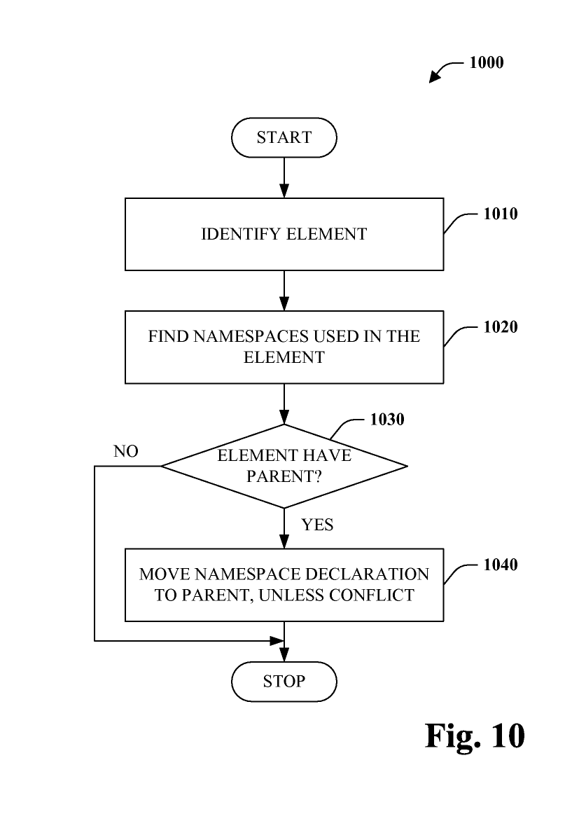

Referring to FIG. 10, a method of namespace declaration removal 1000 is depicted in accordance with an aspect of the claimed subject matter. At reference numeral 1010, an element such as an XML element is identified. All namespaces used by the element are identified at numeral 1020. At 1030, a determination is made as to whether the element as a parent. If not, the method simply terminates. If the element does have a parent, the method continues at reference 1040 where the element namespace declaration is removed from the element and inserted into the parent or container element. In other words, the namespace declaration is moved from a child to its parent. It should be appreciated that method 1000, can begin its analysis of elements at leaf elements and move up to the root in a bottom up manner.

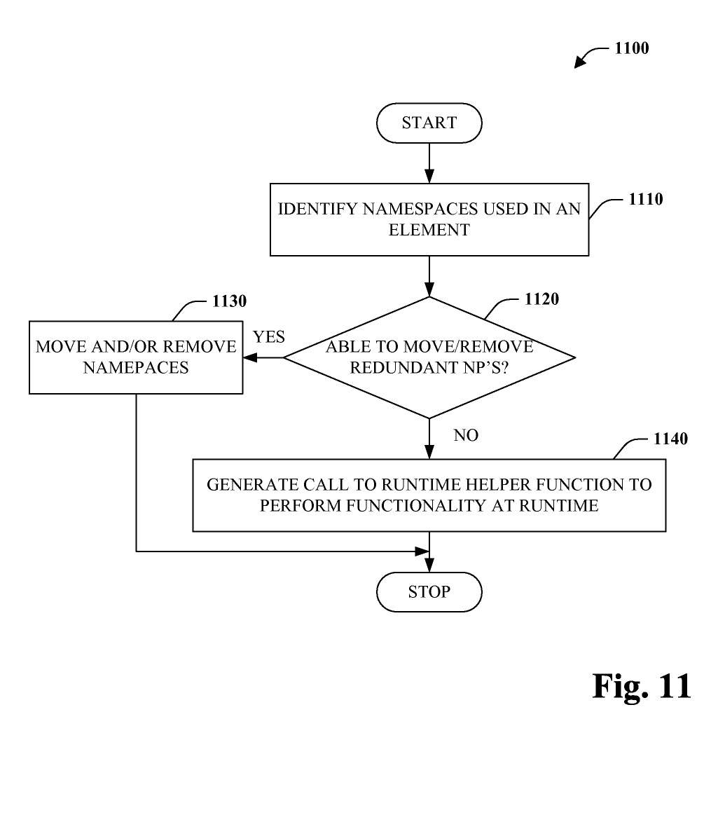

FIG. 11 is a compile-time namespace-declaration removal method 1100 in accordance with an aspect of the claimed subject matter. At numeral 1110, namespaces that are in scope for a particular element are identified. At reference 1120, a determination is made as to whether it can be determined statically that a namespace declaration should be removed and/or moved. If yes, namespace declarations are removed and/or moved as appropriate to eliminate redundant or unnecessary namespace declarations at reference numeral 1130. If no, a determination cannot be made statically, at 1140, a call is generated to a runtime helper function or the like to perform or initiate performance of the same functionality at runtime. In accordance with one aspect, the call can include compile-time information such as in scope namespaces, among other things, so as to reduce or eliminate duplicative work.

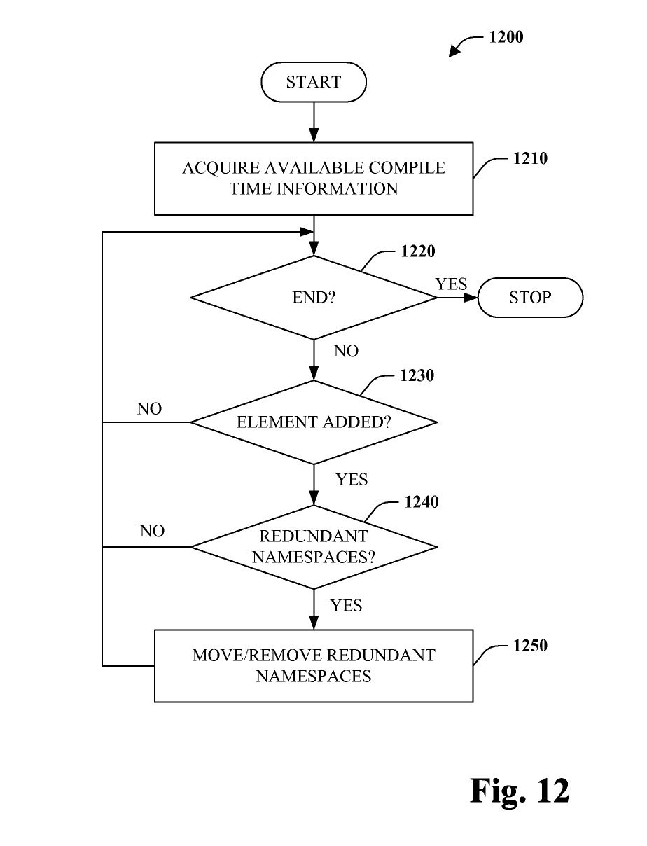

FIG. 12 is a flow chart diagram of a runtime method of namespace declaration removal 1200 in accordance with an aspect of the claimed subject matter. At reference numeral 1210, compile time information such as in scope namespaces or the like is acquired. A check is made as to whether the method has reached an end at 1220. If so, the method terminates. Alternatively, the method continues at reference numeral 1230, where a determination is made as to whether an element has been added. If no, the method continues at 1220. If yes, the method proceeds at numeral 1240 where a check is made concerning whether there are any redundant or unnecessary namespace declarations. If there are not any redundant namespaces, the method continues at 1220. Alternatively, at reference numeral 1250, redundant namespaces are removed and/or moved and the method proceeds at 1220.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

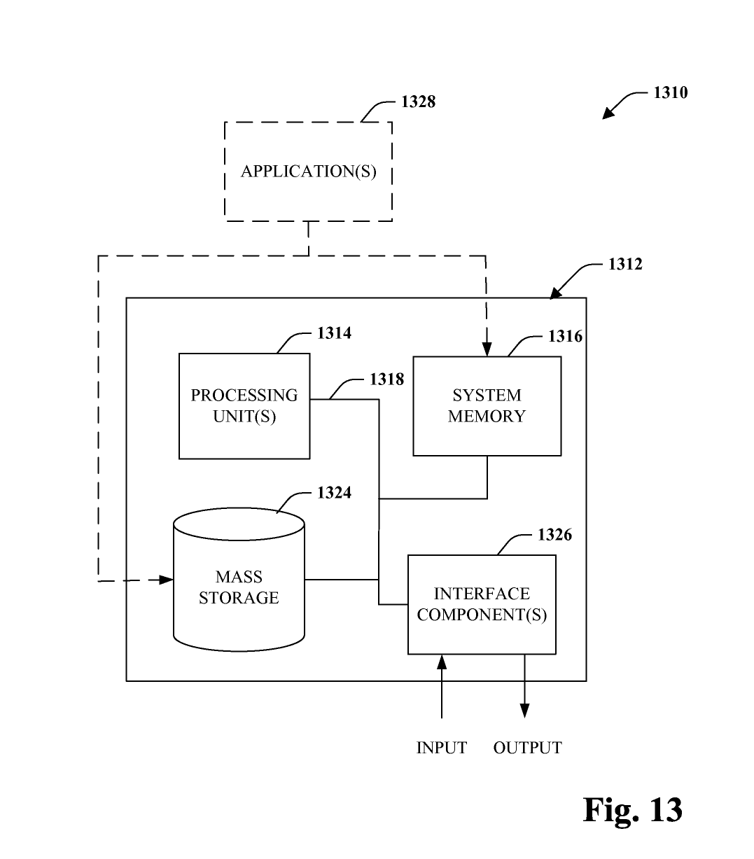

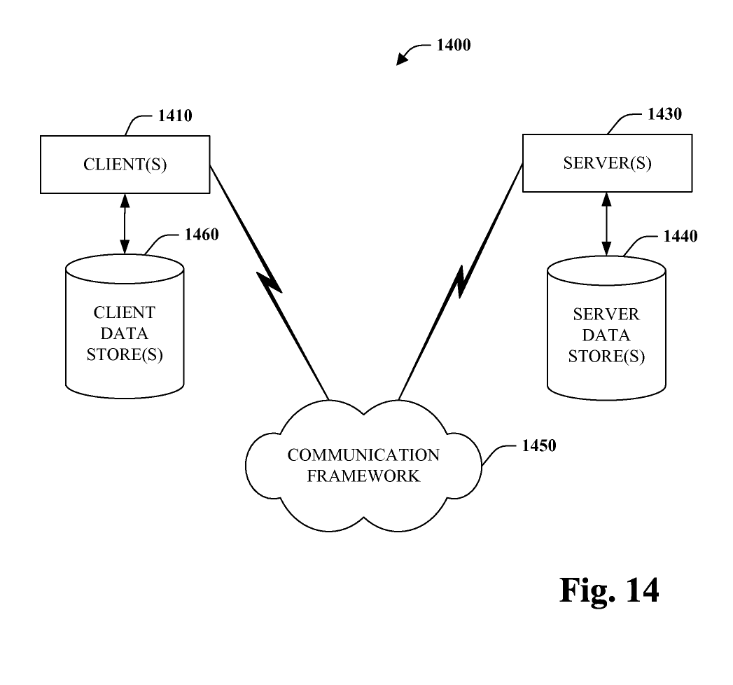

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316, and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 1314.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory, or memory stick. In addition, mass storage 1324 can include storage media separately or in combination with other storage media.

FIG. 13 provides software application(s) 1328 that act as an intermediary between users and/or other computers and the basic computer resources described in suitable operating environment 1310. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1312 to output device(s) via interface component 1326. Output devices can include displays (e.g., CRT, LCD, plasma . . . ), speakers, printers and other computers, among other things.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

Client/server interactions can be utilized with respect with respect to various aspects of the claimed subject matter. By way of example and not limitation, one or more of the components or systems can be employed as a network or web service provided by one or more servers 1430 to one or more clients 1410 over the communication framework 1450. In particular, the entire compilation system 100 of FIG. 1 or portions thereof can be offered as network services.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A compiler system, comprising:
a component that receives compositionally specified input; and
a transform component that maps the input to an imperative application-programming interface to effect the specified function in a manner that avoids unnecessary memory allocation and parameter copying in construction of the input.

2. The system of claim 1, the input is a language-integrated expression literal.

3. The system of claim 2, the expression is specified in a markup language

4. The system of claim 3, a markup element is mapped to a constructor that takes a name of the element as an argument, and child elements or attributes are injected with a series of add method calls.

5. The system of claim 3, further comprising a component that caches element names and/or namespaces to avoid a table lookup and/or string comparison during construction.

6. The system of claim 5, the element names and/or namespaces are hoisted to variables and reused.

7. The system of claim 3, further comprising a namespace component that removes redundant namespaces associated with markup elements.

8. The system of claim 7, the namespace component moves a namespace declaration to a parent element.

9. The system of claim 7, the namespace component operates at compile time and runtime.

10. The system of claim 7, information collected at compile time is available at runtime.

11. A method of compiling expressions, comprising:
acquiring compositional expressions integrated within a host program language;
transforming the expressions into statements of an imperative application programming interface to effect host language implementation; and
removing redundant namespace declarations at compile time and/or runtime.

12. The method of claim 11, further comprising moving a namespace declaration to a parent or ancestor expression element.

13. The method of claim 12, moving solely global namespaces that are declared using an imports statement and local declarations that match global declarations.

14. The method of claim 12, further comprising determining statically that a namespace declaration can be moved, and moving the namespace declaration at compile time.

15. The method of claim 11, further comprising generating a call to a runtime helper function to determine at runtime when assembling expressions whether a declaration can be moved and/or removed where the determination is unable to be made statically at compile time.

16. The method of claim 11, further comprising removing a local namespace declaration with a different prefix than another prefix associated with the same namespace declaration in scope.

17. The method of claim 11, further comprising passing information assembled during compilation to runtime to facilitate removal of namespaces at runtime.

18. A method of compilation, comprising:
acquiring a markup language input literal;
mapping the literal to one or more statements in accordance with an imperative application programming interface; and
caching one or more literal names and/or namespaces to avoid table lookup when constructing the literal.

19. The method of claim 18, further comprising constructing a unique object for each name and/or namespace string associated with a literal element.

20. The method of claim 19, further comprising specifying name lookup on a namespace object to produce a name object.
